(19) United States
(12) Patent Application Publication
(10) Pub. No.: US 2019/0300353 A1
(43) Pub. Date: Oct. 3, 2019

(54) FOOD- OR DRINK-DISPENSING MACHINE AND HOLDER FOR USE THEREWITH

(71) Applicant: Sell gmbh, Herborn-Burg (DE)

(72) Inventors: Peter Podlasin, Steffenberg-Steinperft (DE); Thomas Schaefer, Fronhausen (DE); Siegfried Adomeit, Muecke (DE); Arno Muth, Mittenaar Bicken (DE)

(21) Appl. No.: 15/937,537

(22) Filed: Mar. 27, 2018

(51) Int. Cl. B67C 3/00

(52) U.S. Cl. CPC B67C 3/007

(57) ABSTRACT

A holder for a food or drink component in a food or drink preparation machine includes a housing, a support constructed for reception of a food or drink component, a locking and guiding mechanism and a front panel for actuating the locking and guiding mechanism. The support is movable in a guide out of the housing with respect to a front side of the holder from a moved-in end position to a moved-out end position, and can be shifted by the locking and guiding mechanism to a fixing position, a securing position or an unlocking position. The locking and guiding mechanism in the fixing position retains the support in the moved-in end position relative to the housing, in the securing position blocks uncontrolled movement out of the housing of the support in a securing position, and in the unlocking position allows movement of the support out of the housing section.

### FIELD OF THE INVENTION

The present invention relates to a holder constructed for holding at least one food or drink component and is provided for or received in a food or drink preparation machine, particularly for preparation of a beverage and/or a meal in a galley of an aircraft. In addition, the invention relates to a food or drink preparation machine provided particularly for an aircraft galley, with a holder.

### BACKGROUND OF THE INVENTION

Current food and drink preparation machines for preparation, in portions, of a beverage and/or a meal such as, for example, a soup are designed in such a way that they comprise a holder for holding a receptacle or a container with at least one food or drink component received therein. The holder is frequently designed as a support withdrawable from the food or drink preparation machine and that, after unlocking of the support by manual actuation of a rotary slide or a lever of the food or drink preparation machine, can be pulled or moved at least partly out of a housing of the food or drink preparation machine. After the receptacle or the container with the food or drink component received therein has been placed in the pulled-out or moved-out support the support is pushed or moved into the food or drink preparation machine and subsequently locked in the pushed-in position by manual actuation of the rotary slide or lever of the food or drink preparation machine.

If this rotary slide or lever is not completely transferred to its locking position then the support can loosen, particularly due to shaking or shock, and move out of the food or drink preparation machine without user actuation. If the food or drink preparation machine is configured for preparation of the beverage and/or the meal by supplying hot water under pressure it is particularly dangerous if the support is not fully transferred to the locking position. Known mechanical locks that guarantee secure locking require operation by two hands and/or significantly detract from the visual appearance of the food or drink preparation machine.

Known electrically actuated locks or sensors for detecting the locking state are susceptible to fault and are maintenance-intensive. These problems are of particular concern when the food or drink preparation machine has to be used in an aircraft, in which on the one hand very high safety requirements apply, but on the other hand only a small amount of space is available and cabin crew very often have to operate the food or drink preparation machine under a high level of time pressure.

### OBJECT OF THE INVENTION

The present invention therefore has the object of providing for a food or drink preparation machine a holder for holding at least one food or drink component that can guarantee simple recognition of insecure locking and thus guarantee secure locking during the food or drink preparation and at the same time can prevent uncontrolled movement out of the support in the case of insecure locking. In addition, the intention is that a secure holder of that kind does not detract from the visual appearance of the food or drink preparation machine.

### SUMMARY OF THE INVENTION

The object of the present invention is attained by a holder as presented below. The holder is constructed for holding at least one food or drink component and is provided for a food or drink preparation machine or received therein. The food or drink preparation machine is provided for preparation of a beverage and/or a meal, particularly in a galley of an aircraft. The holder includes a housing, a support constructed for reception of a food or drink component, a locking and guiding mechanism and a front panel for actuating the locking and guiding mechanism. The support is movably mounted in the housing, is movable in guided manner out of the housing with respect to a front side of the holder from a moved-in end position to a moved-out end position, and can be shifted by the locking and guiding mechanism to a fixing position, a securing position or an unlocking position. The locking and guiding mechanism is constructed in the fixing position to fix the support in the moved-in end position relative to the housing, in the securing position to block uncontrolled movement out of the housing of the support in a securing position, and in the unlocking position to allow movement of the support out of the housing section. The locking and guiding mechanism is constructed to move the support in guided manner relative to the housing in reaction to application of force to the support. The front panel is to be movably mounted at the front side of the holder, in particular at the support. In addition, the locking and guiding mechanism is constructed to shift the support from the fixing position to the securing position by a first external force applied in a first predetermined direction to the front panel and from the securing position to the unlocking position by a second external force subsequently applied to the front panel in a second predetermined direction different from the first predetermined direction. Moreover, the holder is so constructed that the front panel in the fixing position projects less from the support than in the securing position and the unlocking position.

By applied external force a force is understood that is applied at least indirectly to the support, especially directly to the front panel at the front side of the holder, by a user present at the front side of the holder, thus externally with respect to the holder. The applied external force is converted by the locking and guiding mechanism into a guided straight-line and/or rotational movement of the support together with the front panel and/or a movement of the front panel relative to the support. The applied external force is an externally applied force.

A precondition for this guided movement and the transfer of the support to another state is that the respective external force is applied to the front panel in a respective predetermined direction. The predetermined direction of the first external force and the predetermined direction of the second external force are different from one another, at least by an angle of 70°, and are preferably opposite to one another. For preference, the predetermined direction of the first external force corresponds with the direction of movement out of the support and/or is directed upwardly, thus opposite to the direction of gravitational force. The predetermined direction of the first external force can change in accordance with a predetermined directional path. If, for example, the front panel is rotatably mounted on the support, the predetermined directional path corresponds with a rotational movement of the front panel from the position of bearing against the support to the position projecting from the support. The predetermined direction of the second external force is preferably oriented transversely to the direction of movement out of the support, with a maximum difference of 30°. The predetermined direction of the second external force is preferably oriented downwardly, thus in the direction of gravitational force, when the predetermined direction of the first external force corresponds with the direction of movement out and/or upward direction. By virtue of the different predetermined directions the second external force can be applied directly, thus without a predetermined minimum delay in time, consecutively to the first external force.

By uncontrolled movement out there is understood a movement out of the support—without application of force to the holder by a user—due to gravitational force or due to shock and shaking such as occurs, for example, during operation of an aircraft. An controlled movement out requires a user of the holder to apply the second external force to the support, particularly to the front panel, from the front side of the holder so as to shift the support from the securing position to the unlocking position and subsequently the user pulls the support in the unlocking position out of the housing. The second external force is preferably at least ten times greater than the weight force of those components of the holder that are movable out of the housing thereof in the unlocking position.

In the case of the presented holder an insecure locking of the holder that has been produced by, for example, unintended contact of a person with the front panel, can thus be very simply recognized visually and by touch in that in the case of an insecure locking the front panel projects from the support and only in the case of a secure locking, thus in the case of fixing of the support in the moved-in position, does the front panel bear as closely as possible or most tightly against the support. In addition, the locking and guiding mechanism precludes uncontrolled movement out of the support.

Insecure locking or unintended unlocking is also prevented by the fact that the support of the presented holder can be shifted to the unlocking position only by application of the second external force that follows the first external force in terms of time and has a direction different from the first external force, to the front panel.

Since the front panel in the fixing position neither juts out from the support nor is deflected or pivoted out from this, but bears tightly against the support, the visual appearance of a food or drink preparation machine provided with the presented holder is not impaired.

In a development of the presented holder it is provided that the locking and guiding mechanism is constructed for guided straight-line and/or rotational movement of the support from the fixing position to the securing position in reaction to the first external force applied to the front panel, wherein the rotational movement is formed by a rotation of the support through a first predetermined angle of preferably 1 to 20°, particularly preferably 2 to 10°, very particularly preferably from 3 to 7°. The first external force is applied by a user who, for example, engages with one hand behind a lower section of the front panel and pulls the front panel in order to thereby produce an upwardly directed rotational movement of the front panel.

In a development of the presented holder it is provided that the locking and guiding mechanism is constructed for guided straight-line and/or rotational movement of the support from the securing position to the unlocking position in reaction to the second external force applied to the front panel, wherein the rotational movement is formed by a rotation of the support through a second predetermined angle of preferably at least 3°, particularly preferably at least 5°. This rotation through the second predetermined angle is in the same direction as the rotation through the first predetermined angle. Through the first and second external forces applied in succession to the front panel the support is thus rotated relative to the housing—in the transition from the fixing position to the unlocking position—in total by the sum of the first and second predetermined angles with respect to the position in the fixing position. The second external force is applied by a user who, for example, presses by one hand against the front panel and/or support in downward direction, thus in the direction of gravitational force.

In a development of the presented holder it is provided that the locking and guiding mechanism is constructed to restore the support automatically, for example by a spring force device of the locking and guiding mechanism, to the securing position if directly after reaching the unlocking position there is no application of a third external force to the front panel for drawing out the support. The third external force has to be applied by the user in a predetermined direction oriented in the direction of movement out of the support. The predetermined directions of the second and third external forces differ from one another, preferably by at least 60°.

In a development of the presented holder it is provided that the locking and guiding mechanism is constructed for guided straight-line and/or rotational movement of the support from the securing position to the fixing position in reaction to a fourth external force applied to the front panel, particularly in the direction of movement of the support into the housing, together with a movement of the front panel relative to the support. The fourth external force is applied by a user who presses from the front side of the holder against the front panel in order to produce a rotational movement of the front panel opposite to the rotational movement of the front panel produced by the first external force.

In a development of the presented holder it is provided that the locking and guiding mechanism comprises a first guide device for guidance of the support relative to the housing along a predetermined first guide path with a first guide path section associated with the fixing position and the securing position and a second guide path section associated with the unlocking position. For preference the first and second guide path sections span an obtuse angle at their transition. For preference, at least the second guide path section extends rectilinearly.

In a development of the presented holder it is provided that the locking and guiding mechanism is constructed for blocking a movement of the front panel relative to the support in the unlocking position. As a result, the application of force required for movement of the support into the unlocking position, of a user is reduced, because an external force applied by a user to the front panel is converted as fully as possible into a movement in or movement out of the support.

In a development of the presented holder it is provided that the locking and guiding mechanism is constructed for transforming a movement, in particular a rotational movement, of the front panel relative to the support into a guided straight-line and/or rotational movement of the support. Thus, it is possible by a rotational movement of the front panel to raise the support from the securing position to the moved-in end position and by an opposite rotational movement of the front panel to lower the support from the moved-in end position to the securing position.

In an enhancement of the above development it is provided that the locking and guiding mechanism comprises a force deflector rotatably secured to the support and formed as, in particular, a rocker arm and is rotated by the movement, in particular rotational movement, of the front panel. The force deflector designed as a rocker enables a force-saving coupling of a rotational movement of the front panel with a movement of the support particularly advantageous for single-handed operation of the presented holder.

In an enhancement of the above enhancement it is provided that the locking and guiding mechanism comprises a second guide device for guidance of a section of the force deflector along a predetermined second guide path associated with the unlocking position, and for fixing the projecting position of the front panel by the force deflector.

A development of the presented holder is, moreover, provided with a spring force device for providing a force for retaining the support in the securing position. As a result, an uncontrolled movement out of the support in the securing position is avoided or at least limited. Alternatively or optionally the spring force device is constructed for providing a force for reinforced fixing of the support in the moved-in end position. The support can thereby also be securely held in the fixing position even in the case of large external forces.

A development of the presented holder is designed for external loads of the support in the moved-out end position of at least 1,000 Newtons. Safer operation of the holder in aircraft is thereby made possible. The holder is not damaged if due to the turbulence a member of the cabin crew supports himself or herself on the fully moved-out support or impinges on this by a part or his or her body.

A development of the presented holder is constructed to be free of electrics and electronics. As a result, a high level of security against failure and a lengthy maintenance-free service life of the holder is made possible.

In a development of the presented holder is provided that the holder comprises a fluid feed device for providing a fluid, particularly water or steam, or can be coupled with it. In addition, it is provided the holder is arranged and constructed for reception of the fluid provided by the fluid feed device and for feeding the fluid to the support, particularly to a food or drink component received therein, only in the fixing position.

The object of the present invention is also fulfilled by a food or drink preparation machine provided with the presented holder or one of its developments and enhancements. The food or drink preparation machine is provided particularly for a galley of an aircraft.

In a development, the presented food or drink preparation machine is provided with a surface section on a front side of the food or drink preparation machine and in which the front panel of the holder is integrated, wherein the front panel in the securing position projects from the surface section and in the fixing position does not project from the surface section. It is thereby ensured that insecure locking can be readily recognized visually and by touch. Moreover, the front panel in the fixing position does not detract from the visual appearance of the food or drink preparation machined.

### BRIEF DESCRIPTION OF THE DRAWING

The above and other objects, features, and advantages will become more readily apparent from the following description, reference being made to the accompanying drawing in which:

FIG. 1 is a schematic side view of an embodiment of a holder according to the invention in the fixing position;

FIG. 2 is a schematic side view of an embodiment of a holder according to the invention in the securing position;

FIG. 3 is a schematic side view of an embodiment of a holder according to the invention in the unlocking position;

FIG. 4 illustrates movements of components of the embodiment illustrated in FIG. 1 to FIG. 3, of the holder according to the invention in the transition to the fixing position;

FIG. 5 is a perspective view of an embodiment of a food or drink preparation machine in accordance with the invention with a holder according to the invention in the fixing position;

FIG. 6 is a perspective view of an embodiment of a food or drink preparation machine in accordance with the invention with a holder according to the invention in the securing position;

FIG. 7 is a perspective view of an embodiment of a food or drink preparation machine in accordance with the invention with a holder according to the invention in the unlocking position, with an incompletely moved out support; and

FIG. 8 is a perspective view of an embodiment of a food or drink preparation machine in accordance with the invention with a holder according to the invention in the unlocking position, with a completely moved out support.

### SPECIFIC DESCRIPTION OF THE INVENTION

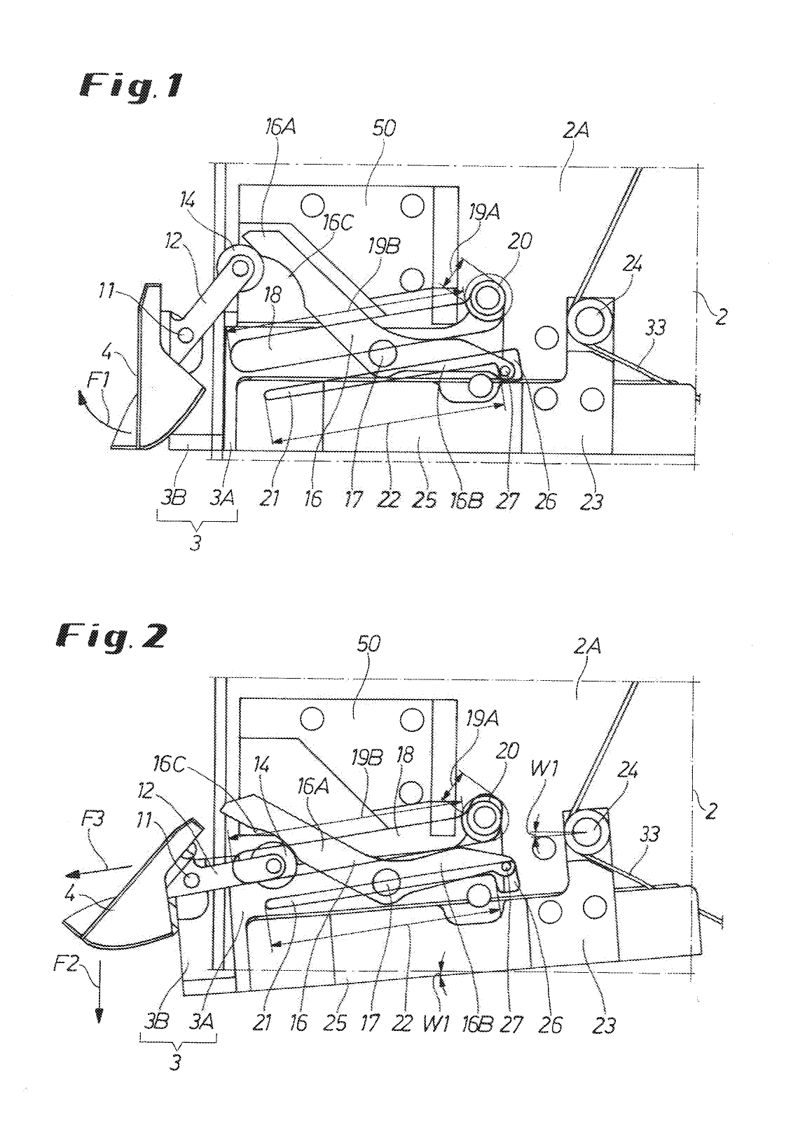

The holder 1 schematically illustrated in FIGS. 1-3 comprises a housing 2, a support 3, a front panel 4 and a locking and guiding mechanism with elements 12 to 33. A side wall section 2a of the housing 2 is illustrated in transparent form in FIG. 1, FIG. 2 and FIG. 3 for better illustration of the form and arrangement of the support 3 and the locking and guiding mechanism of the illustrated embodiment, these being at least partly in the housing 2.

The support 3 is, by way of example, of multi-part construction consisting of a support base body 3A and a support front body 3B that are rigidly connected together. The support base body 3A has at least one recess (not shown) for reception of at least one food or drink component, which recess is designed for holding receptacles such as, for example, a container with a food or drink component received therein. The support front body 3B is mounted on the end of the support base body 3A towards the front side of the holder 1. In FIG. 1, FIG. 2 and FIG. 3 the front side of the holder 1 is disposed in each instance in the side section on the left. A rotary bearing 11 is provided at the support front body 3B.

The front panel 4 is attached by the rotary bearing 11 to the support base body 3A of the support 3 to be rotatable within a predetermined angular range.

For better illustration, only the locking and guiding mechanism on the right-hand side of the support is illustrated in FIG. 1, FIG. 2 and FIG. 3. For stable and secure guidance of the support 3 the locking and guiding mechanism is provided at the right-hand side and at the lefthand side (not shown in FIGS. 1 to 3) of the support 3. The locking and guiding mechanism in the illustrated embodiment comprises—for each of the right-hand and lefthand sides respectively—a lever arm 12, a contact roller 14, a force deflector 16 formed as a rocker, a first guide device 18 with a guide roller 20, a second guide device 21, a rotary support 23, a rotary bearing 24, a spring-force device 33, and a withdrawable guide rail 25. However, in departure from the illustration the locking and guiding mechanism can also be provided at one side, for example only on the right-hand or lefthand side, and/or centrally.

One end of the lever arm 12 is so attached to the front panel 4 that a rotational movement of the front panel 4 is converted into a rotational movement or pivot movement of the lever arm 12. A rotatably mounted contact roller 14 is attached to the other end of the lever arm 12 remote from the front panel 4. The contact roller 14 is so arranged and dimensioned that at least in the fixing position and in the unlocking position it is in permanent mechanical contact with the force deflector 16.

The force deflector 16 is formed as a rocker and is rotatably attached to the support front body 3B by a rotary joint 17. A lever arm 16A that faces the front panel 4, of the force deflector 16 is so constructed and arranged that it is in the afore-mentioned mechanical contact with the contact roller 14. The lever arm 16B remote from the front panel 4 is provided with a guide pin 27, the position or movement of which is guided by the second guide device 21.

The rotary support 23 of the locking and guiding mechanism is rotatably attached to the inner side of the side wall section 2A of the housing 2 by the rotary bearing 24. The rotary support 23 is mechanically coupled to the support base body 3A by way of the withdrawable guide rail 25. Through the arrangement as described above and mechanical coupling of the rotary support 23, the rotary bearing 24, the withdrawable guide rail 25 and the support base body 3A, the support 3 is movable rotationally or in a straight line relative to the housing 2 and can be moved out of and moved into the housing 2.

The locking and guiding mechanism is provided with the first guide device 18 and the guide roller 20 for guidance of the straight-line and rotational movement of the support 3 relative to the housing 2.

The guide roller 20 is attached to the support base body 3A to be rotatable about an axis of rotation and is movable along a first guide path 19 predetermined by the first guide device 18. The first guide device 18 is, as shown in FIG. 1, FIG. 2 and FIG. 3, formed as a material recess or as a through-hole in the form of a wide, angled slot in the side wall section 2a. The first guide path 19 predetermined by the first guide device 18, is composed of a first guide path section 19A associated with the fixing position and the securing position and a second guide path section 19B associated with the unlocking position. The second guide path section 19B extends rectilinearly and is not curved. The guide path sections 19A and 19B include, at their transition, an obtuse angle of preferably more than 100°. The straight-line and/or rotational movement of the support in the unlocking position, thus movement of the support out of or into the housing, is predetermined by the guide roller 20 guided along the second guide path section 19B. As illustrated in FIG. 1, FIG. 2 and FIG. 3, the second guide path section 19B extends not horizontally, but with a constant negative gradient from the transition to the unlocking position up to the moved-out end position. The moved-out end position of the support 3 is defined by an end that faces the front side of the holder, of the second guide path section 19B.

The second guide device 21 of the locking and guiding mechanism of the holder 1 is constructed for guiding the guide pin 27 secured to the lever arm 16B of the force deflector 16 and that represents a section of the force deflector, along a predetermined second guide path 22 associated with the unlocking position. The second guide device 21 is, as shown in FIG. 1, FIG. 2 and FIG. 3, formed as a material recess or as a slot-like through-hole in the side wall section 2a. The second guide path 22 of the second guide device 21 is formed in such a way that rotation of the force deflector 16 relative to the support 3 during the unlocking position is blocked. As a result, the front panel 4 is fixed in its position projecting from the support 3 by way of the contact roller 14 and the lever arm 12 in the unlocking position. As shown in FIG. 1, FIG. 2 and FIG. 3, the second guide path section 19B of the first guide device 18 and the second guide path 22 of the second guide device 21 that are both associated with the unlocking position, are arranged as corresponding slot-like through-holes in the side wall section 2A to be offset parallel to one another.

A slot-like widening 26 oriented at right angles to the second guide path 22 is provided in the side wall section 2A at the end remote from the front panel 4, of the second guide path of the second guide device 21. The widening 26 is formed so as to enable rotational movement of the force deflector 16 about the axis 17 of rotation thereof.

The fixing position of the support 3 and of the locking and guiding mechanism of the holder 1 according to the invention is illustrated in FIG. 1. The support 3 has a horizontal disposition in the moved-in end position. The guide roller 20 is pressed against the end of the first guide path section 19A of the first guide path 19 of the first guide device 18. The front panel 4 lies as closely as possible to the support front body 3B. The contact roller 14 is in mechanical contact with the outer end section of the lever arm 16A of the force deflector 16 and blocks movement of the force deflector 16. The spring force device 33 provides a force that, when the force deflector 16 is not blocked, would lead to a rotation of the force deflector in anticlockwise sense. Due to the provided force, the lever arm 16a is pressed more strongly against the contact roller 14, whereby fixing of the support 3 in the moved-in end position is reinforced. This makes it possible for the holder to also remain securely in the fixing position if a fluid at high pressure, for example from a fluid feed device 50 schematically illustrated in FIGS. 1-3, is applied to the support 3 or to a food or drink component received therein. The guide pin 27 is located in the widening 26 so as to allow rotation of the force deflector 16 and thus also movement of the front panel 4 relative to the support 3 by an external force applied to the front panel 4.

The securing position of the support and of the locking and guiding mechanism of the holder 1 according to the invention is illustrated in FIG. 2 that arises when a user applies to the front panel 4 of the holder 1 in the fixing position illustrated in FIG. 1 a first external force F1 initially oriented in the direction of movement out of the support and leads to rotation of the front panel 4 into a state projecting from the support 3 as illustrated in FIG. 2, wherein the directional plot of the force F1 corresponds with the rotation of the front panel 4. In order to make possible this rotation of the front panel 4 the lever arm 16A is provided with a trough-like surface 16C along which the contact roller 4 is guided during rotation of the front panel 4 into the position projecting from the support 3. The rotational movement of the front panel 4 in clockwise sense is accompanied by rotational movement of the force deflector 16 about the axis of rotation of the rotatory bearing 17 in anticlockwise sense and rotational movement of the support 3, to which the force deflector 16 is movably attached, in anticlockwise sense. This rotational movement of the support 3 through approximately 5° (see angle W1 in FIG. 2), by which the support 3 is lowered and inclined by comparison with the horizontal position, is guided by the guide roller 20 guided in the first guide path section 19A of the first guide device 18. The extent of movement is also determined by the spring force provided by the spring force device 33. The guide pin 27 is transferred by the movement of the force deflector 16 to the start of the second guide path 22 of the second guide device 21.

The unlocking position of the support and of the locking and guiding mechanism of the holder 1 according to the invention in the moved-out end position is illustrated in FIG. 3 that state arises when a second external force F2 that urges the support downwardly, is applied—subsequently to the first external force F1—by the user to the front panel 4 of the holder 1 in the securing position illustrated in FIG. 2. The force F2 is thus oriented downwardly and transversely to the direction of movement out of the support. The second external force F2 has to be of sufficient magnitude to overcome an opposing force provided by the spring force device 33 in the securing position and that prevents further rotation of the support beyond the already effected rotation of approximately 5° (=angle W1), and to transfer the guide roller 20 from the first guide path section 19A to the second guide path section 19B of the first guide device 18 at the transition together include an obtuse angle. Through application of the second external force F2, the support 3 by comparison with the securing position is rotated, additionally to the rotation through approximately 5° (=angle W1) at the time of transition from the fixing position to the securing position, through approximately a further 5° (=angle W2) in the same direction of rotation. In order that the unlocking position is maintained, a third external force F3 has to be applied by the user to the front panel 4 directly after application of the second external force F2. The third external force F3 is oriented in the direction of movement out of the support 3. Without application of the external force F3, the support 3 is restored by the force of the spring force device 33 back to the securing position. In the unlocking position, the support 3 is guided along the second guide path section 19B of the first guide device 18 by the guide roller 20 attached to the support 3, during movement out or movement in. By comparison with the horizontal position of the support 3 in the fixing position, the support 3 in the unlocking position is inclined or lowered by the sum of the angles W1 and W2, thus by approximately 10°.

The holder 1 illustrated in FIGS. 1-3 is intended for use in a galley of aircraft and is constructed for external loading of the support in the moved-out end position of at least 1,000 Newtons. In addition, the holder 1 is of electrically-free and electronically-free design.

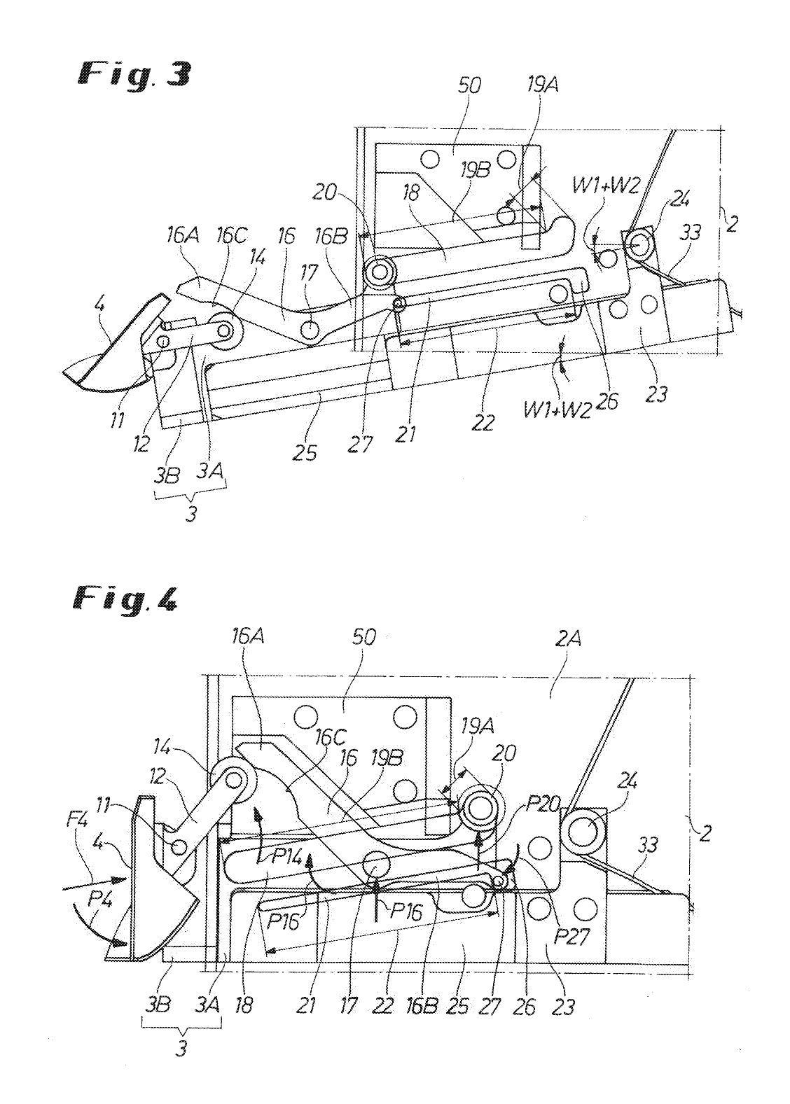

Movements of components of the embodiment of the holder according to the invention illustrated in FIGS. 1-3 at the time of transition from the securing position to the fixing position are depicted by arrows in FIG. 4. An arrow with the reference Px denotes in FIG. 4 a movement of the component x on transition from the securing position to the fixing position. In order to transfer the locking and guiding mechanism and the support from the unlocking position to the fixing position via the securing position a fourth external force F4 oriented in the direction of movement in of the support has to be applied by a user to the front panel 4. However, the components of the holder 1 are depicted in the state illustrated in FIG. 1, thus in the already achieved fixing position, for reasons of simplified illustration.

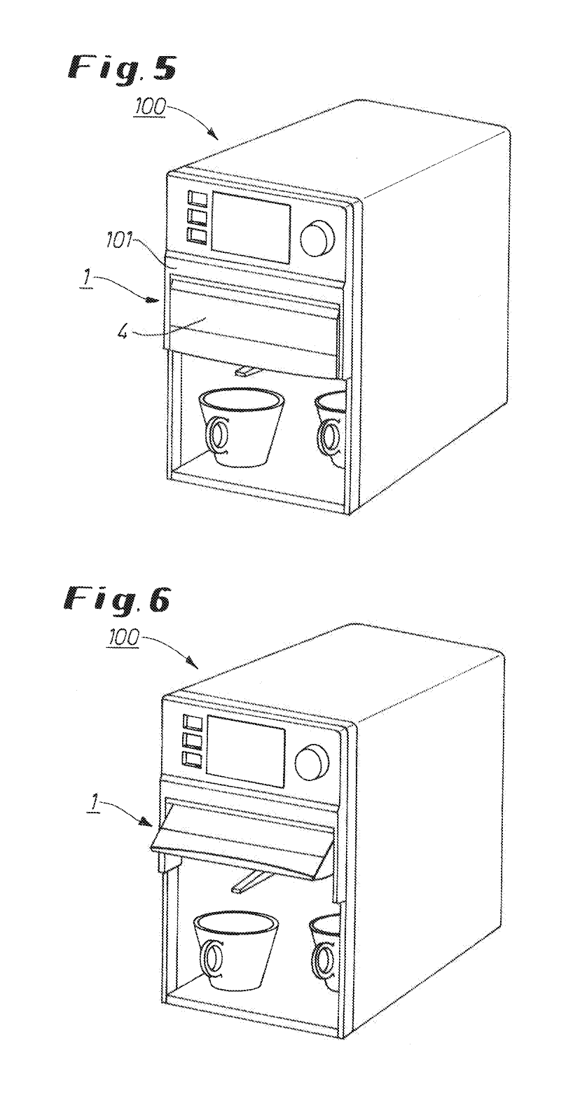

FIGS. 5-8 show an embodiment of a food or drink preparation machine in accordance with the invention with the embodiment presented in the foregoing, of the holder according to the invention in perspective illustration respectively in the fixing position, the securing position, the unlocking position with incompletely moved-out support and the unlocking position with completely moved-out support. The illustrated food or drink preparation machine 100 is constructed as a cocoa preparation machine (and/or, for example, as a coffee machine and/or espresso machine) provided with the holder 1 presented in the foregoing. The support 3 of the holder 1 has two recesses 60 that are each constructed for reception of a container (not shown) filled with cocoa milk powder (alternatively: coffee grinds). Arranged in the food or drink preparation machine 100 is a fluid feed device (not shown) coupled with the support 3 or the holder 1 for the feed of hot water under high pressure only when the support 3 is in the fixing position illustrated in FIG. 5. The supplied hot water is forced through a membrane or opening of the container and subsequently into the cocoa milk powder (alternatively: coffee grinds) (alternatively: contains) a food/drink component. The thereby-produced cocoa milk (alternatively: coffee liquid) is subsequently transferred from the container to one or more cups below the support 3.

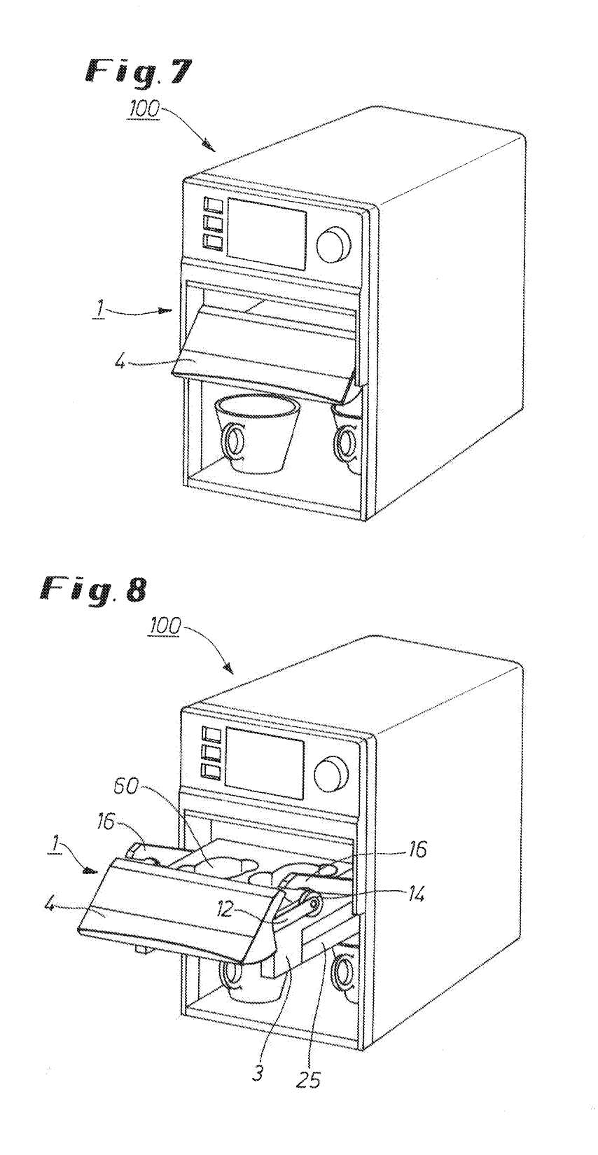

A surface section 101 in which the front panel 4 of the receiving 1 is integrated is on the front side of the food or drink preparation machine 100. In the fixing position illustrated in FIG. 5 the front panel 4 does not project beyond the surface section 101, but is flush with the surface section 101. In the securing position illustrated in FIG. 6 the front panel 4 projects at an inclination from the surface section 101 and does not bear tightly against the support 3. This also applies to the fixing position of the support 3 shown in FIG. 7 and FIG. 8. It is additionally illustrated, by way of example, in FIG. 8 that the above-mentioned components of the locking and guiding mechanism are respectively provided on the right hand side and the lefthand side of the support.

1. A holder constructed for holding a food or drink component and intended for or received in a food or drink preparation machine, the holder comprising:
a housing;
a support constructed for holding the food or drink component and movably mounted in the housing and movable under guidance out of the housing with respect to a front side of the holder from a moved-in end position to a moved-out end position and transferrable by a locking and guiding mechanism into a fixing position, a securing position or an unlocking position;
the locking and guiding mechanism constructed to fix, in the fixing position, the support in the moved-in end position relative to the housing, to block, in the securing position, an uncontrolled movement out of the housing of the support in a securing position and to allow, in the unlocking position, movement of the support out of the housing section; and
a front panel arranged to be movably mounted at the front side of the holder, for actuating the locking and guiding mechanism, the locking and guiding mechanism being constructed to shift the support from the fixing position to the securing position by a first external force applied to the front panel and from the securing position to the unlocking position by a second external force subsequently applied to the front panel, the front panel in the fixing position projecting less from the support than in the securing position and the unlocking position.

2. The holder according to claim 1, wherein the locking and guiding mechanism is constructed for guided straight-line and/or rotational movement of the support from the fixing position to the securing position in reaction to the first external force applied to the front panel, wherein the rotational movement is defined by rotation of the support through a first predetermined angle of preferably 1 to 20°.

3. The holder according to claim 1, wherein the locking and guiding mechanism is constructed for guided straight-line and/or rotational movement of the support from the securing position to the unlocking position in reaction to the second external force applied to the front panel, the rotational movement being defined by rotation of the support through a second predetermined angle of preferably at least 3°.

4. The holder according to claim 1, wherein the locking and guiding mechanism is constructed to automatically restore the support to the securing position if directly after reaching the unlocking position no third external force is applied to the front panel for drawing out the support.

5. The holder according to claim 1, wherein the locking and guiding mechanism is constructed for guided straight-line and/or rotational movement of the support from the securing position to the fixing position in reaction to a fourth external force applied to the front panel in a direction of movement of the support into the housing, together with movement of the front panel relative to the support.

6. The holder according to claim 1, wherein the locking and guiding mechanism comprises a first guide device for guidance of the support relative to the housing along a predetermined first guide path with a first guide path section associated with the fixing position and the securing position and a second guide path section associated with the unlocking position, the second path sections preferably forming an obtuse angle at their transition.

7. The holder according to claim 1, wherein the locking and guiding mechanism is constructed for blocking movement of the front panel relative the support in the unlocking position.

8. The holder according to claim 1, wherein the locking and guiding mechanism is constructed for transforming a straight line or rotational movement of the front panel relative to the support into a guided straight-line and/or rotational movement of the support.

9. The holder according to claim 8, wherein the locking and guiding mechanism comprises a force deflector rotatably secured to the support and rotated by the movement, in particular rotational movement, of the front panel.

10. The holder according to claim 9, wherein the locking and guiding mechanism comprises a second guide device for guidance of a section of the force deflector along a predetermined second guide path associated with the unlocking position and for fixing the projecting position of the front panel by the force deflector.

11. The holder according to claim 10, further comprising:
a spring force device for providing a spring force for holding the support in the securing position and/or for providing a force for fixing the support in the moved-in end position.

12. The holder according to claim 1 designed for external loading of the support in the extended end position of at least 1000 Newtons.

13. The holder according to claim 1, wherein the holder is of electrically-free and electronically-free construction.

14. The holder according to claim 1, wherein the holder comprises a fluid feed device for providing a fluid or can be coupled therewith and the holder is arranged and constructed for holding the fluid provided by the fluid feed device and for conducting the fluid to a food or drink component held in the support only in the fixing position.

15. A food or drink preparation machine with a holder according to claim 1, wherein the food or drink preparation machine is intended for an aircraft galley.

16. The food or drink preparation machine according to claim 15, with a surface section on a front side of the food or drink preparation machine and in which the front panel of the holder is integrated, the front panel in the securing position projecting from the surface section and in the fixing position not projecting from the surface section.
